(19) United States
(12) Patent Application Publication
(10) Pub. No.: US 2017/0101774 A1
(43) Pub. Date: Apr. 13, 2017

(54) METHOD OF STRENGTHENING AN EXISTING INFRASTRUCTURE USING SPRAYED-FIBER REINFORCED POLYMER COMPOSITE

(71) Applicant: POLYRAP PAVEMENT SYSTEMS LTD., Kelowna (CA)

(72) Inventor: Anantray PARGHI, Kelowna (CA)

(21) Appl. No.: 15/095,578

(22) Filed: Apr. 11, 2016

Related U.S. Application Data
(60) Provisional application No. 62/146,005, filed on Apr. 10, 2015.

(51) Int. Cl. E04B 1/98; E02D 5/60; E04C 3/36; E02D 5/58; B05D 1/02; E04C 3/34

(52) U.S. Cl. CPC E04B 1/98; B05D 1/02; E04C 3/34; E04C 3/36; E02D 5/58; E02D 5/60

(57) ABSTRACT

A construction technique for strengthening existing infrastructure and its components (e.g. bridge columns) using sprayed fiber reinforced polymer (sprayed-FRP) made of randomly oriented chopped fibers and resins on the said existing deficient infrastructure. Sprayed-FRP composite laminates are applied to reinforced concrete (RC) or steel or wooden or masonry structure substrates as an external reinforcement as effective means for obtaining higher level of fiber utilization before premature failure.

### FIELD OF THE INVENTION

The present disclosure relates to the field of reinforced structures, and in particular to a method of strengthening an existing infrastructure such as reinforced concrete bridges and buildings, masonry structures, timber structures, steel structures using a sprayed-Fiber Reinforced Polymer (FRP) composite having structural deficiency.

### BACKGROUND OF THE INVENTION

Highway bridges play an important role in the development of country's economic activity and bridges are the crucial component of a country's transportation system. Historically, measures were adopted to improve transportation safety, accessibility, and economic efficiency. However, many existing highway bridges were built when the standard guidelines of seismic design were at an early stage of development. Moreover, earthquake hazard levels have been recently increased for some regions throughout the globe, which might affect the seismic performance of existing bridges. Further, the truck loads over the years have increased significantly and often the bridges are restricted to the bridge's load capacity and cannot allow heavier trucks/overincrease traffic volume without proper strengthening. In addition, reinforced concrete bridge columns exposed to corrosion prone areas are more vulnerable to long term structural strength and durability. For example, in regions where the structures are subjected to extreme climate conditions in winter and summer, moisture trapped in the concrete freezes and expands during the winter and as a result the structure cracks.

Various rehabilitation methods are available to upgrade the structural performance of existing substandard bridges. In the past three decades, concrete jacketing and steel plate jacketing have been often used for the structural strengthening of deficient structures. In such a way, significant improvement in ultimate flexural strength and ductility may be achieved. However, these techniques have many problems associated with their use. For example, concrete jacketing is labour intensive and time consuming, and presents a shrinkage and bonding problem with substrate concrete. Another drawback is the reduction of available floor-space, since jacketing enhances the section size which leads to substantial mass increase, stiffness modification, and subsequently modification of the dynamic characteristics of the entire structure. In the case of steel plate jacketing, its needs specialized heavy equipment at the work place, has a high cost, and introduces the likelihood of steel corrosion at the interface of the steel and concrete resulting in bond deterioration. Another disadvantage is the difficulty in manipulating heavy steel plates in tight construction site; which requires scaffolding, and suffers from a limitation in available plate lengths, for example in case of flexural strengthening of long girders resulting necessarily in the use of joints.

In response to growing needs for strengthening and rehabilitation of concrete structures, recently, the use of fiber reinforced polymer (FRP) composite jacket has been increased significantly. It can considerably improve the flexural and shear strengths and enhance the ductility of the column. However, all of these retrofitting techniques have certain disadvantages. For example, good interfacial bond ability among the concrete substrate and FRP laminates must be ensured to improve the retrofit performance of the FRP sheets externally bonded to a concrete structure. Conversely, the FRP sheet reinforcement system has many deficiencies such as the requirement for prior surface treatment, anisotropic properties, problem at joints and relatively expensive materials cost. FRP laminates applied by wet lay-up technique are very sensitive to surface roughness of RC structures. Therefore, bond ability of the FRP laminates bonded to uneven surface can significantly lead to the delamination from the concrete substrate due to a partial stress concentration at a defective interface.

Thus, a need arises to solve the above mentioned difficulties to upgrade the existing infrastructure. The disadvantages of the conventional retrofitting technique could be overcome by the presently disclosed spray-up method. Conventional spray fiber lay-up technique, which produces an anisotropic composite material, has been commercially used for fabrication of water slides, tubs, swimming ponds, boats hull, storage tanks and vessels in lower capacity. In the early-1990s, the sprayed-FRP composite made by a conventional spray lay-up technique was presented at the University of British Columbia in order to retrofit and strengthen deteriorated reinforced concrete horizontal elements (e.g. beams, girders). As discussed earlier, the sprayed-FRP composite material retrofitting technique is quite different from the “fiber reinforced polymer sheet retrofitting method” in both fiber volume and manufacturing process.

In the prior art applicant is aware of the following issued patents and published patent applications which disclose various fiber reinforced polymer retrofitting of reinforced concrete structures: U.S. Pat. No. 4,019,301, U.S. Pat. No. 5,362,542, U.S. Pat. No. 5,599,599, US 2014/0144095, EP 2336455, WO 2006/020261 A2 and WO 2006/032033.

The present invention is distinguished over the prior art by at least the use of secondary containment structures fanned of a randomly oriented fibers along with the vinyl ester resin matrix which could defeat an anisotropic issue of a unidirectional FRP sheet composite. The invention is not limited to the embodiments depicted in the drawings and described in the specification, which are established by the way of illustration and not to the limitation, but only in accordance with the scope of the appended claims.

### SUMMARY OF THE INVENTION

The method as disclosed herein may provide some or all of the following:
(a) a technique for increasing the compressive, flexural and shear strength of deficient reinforced concrete circular bridge columns.
(b) a technique for enhancing the ductility of seismically deficient reinforced concrete circular bridge column.
(c) an emergency repairing and retrofitting technique for the earthquake induced damaged reinforced concrete circular bridge columns.
(d) to provide structural support of concrete column for use in hurricane and seismic zone locations.
(e) a technique for improving lifespan of concrete support piles and columns without the use of surplus steel reinforcing rebar and cages.
(f) a technique for protecting steel reinforcing rebar, if they are used in concrete infrastructure support piles and columns from the effects of corrosion.

The present invention contains numerous embodiments of a sprayed-FRP composite jacketing for enhancing the compressive, flexural and shear strengths of reinforced concrete columns The basic structure includes an external case element and interior with a steel reinforced concrete core. The exterior case is a shell, for example substantially cylindrical, containing fibers along with a resin compound. This method consists of resin (epoxy, vinyl ester or polyester resin) and short randomly oriented chopped fibers of controlled length in a polymer matrix. A circular cylindrical concrete core is located within external case which provides axial compression and circumferential tri-axial reinforcement to the concrete core. The fiber and resin used in external case which may include about 60 to 65% fibers (glass, carbon, aramid and basalt) and nearly 35 to 40% resin. The external case includes a multilayer tube of randomly oriented chopped fibers with certain length and polymer resin matrix sandwiched between inner and outer layers of circumferential randomly distributed fibers. The spray wet layup process consists of a spray gun attachment which chops fiber into predetermined lengths, merge with the resin mix stream and projects to the substrate of concrete. Following this process, the combination of resin and chopped fibers are deposited simultaneously to desired thickness on concrete surface.

The external case has numerous embodiments which includes a circular, square, rectangular or oval cross-section shape. The concrete core may contain materials select from at least one of plain concrete, steel and fiber reinforced concrete, high strength concrete, fiber reinforced and plastic reinforced concrete.

The present disclosure may be characterized in various aspects, which are not intended to be limiting, as follows:

A method of strengthening an existing seismically deficient infrastructure constructed from concrete, masonry, steel and/or timber by externally jacketing the infrastructure in a sprayed fiber reinforced polymer jacket. The infrastructure may have a first deficient area which is first repaired using cement mortar to the existing infrastructure, and then adhering the sprayed-FRP to the repaired existing infrastructure.

A sprayed-fiber reinforced polymer composite member for increasing the compressive, tensile, shear and flexural strengths of reinforced concrete bridge column and supports, the member including:
an external case of sprayed fiber and resin combination where the combination includes about 60 to 65% glass fiber and substantially 35 to 40% vinyl ester resin;
an internal concrete core encasing the external case so as to provide an axial and circumferential reinforcement for the concrete core.

The sprayed fiber reinforced polymer jacketing may include randomly oriented chopped fibers chosen from the group: glass, carbon, basalt and aramid fibers group: in combination with a resin chosen from the group: vinyl ester, polymer and epoxy resin

The external case of the sprayed fiber reinforced polymer composite member may include one layer and/or multilayer of wraps. The multilayer wraps may further include randomly oriented chopped fiber laminated ply.

The multilayer wraps may further include a layer of randomly distributed fibers sandwiching inner and outer layers of circumferential hoops wraps.

The external case may have various, cross-sectional shapes, for example, circular, rectangular or square, elliptical or oval

A sprayed fiber reinforced polymer composite member for increasing the compressive, shear and flexural strengths of concrete columns and supports includes an external multilayer case of a fiber and resin combination, wherein the fiber includes at least one or more of: glass, carbon, basalt and aramid, and the resin includes at least one of vinyl ester, polymer and epoxy

An internal core concrete may be encased, wherein the interior concrete core member and the external multi-layer case provide axial and circumferential reinforcement for the core concrete used as a support column and pile.

The sprayed fiber reinforced polymer composite member may include about 60 to about 65% fibers, and about 35 to about 35% resin by weight or by volume.

The sprayed fiber reinforced polymer composite member may contain an external case formed solely from glass, or formed solely from carbons and a core concrete within the external case, wherein external case provides axial and circumferential reinforcement for the core concrete used as a support column and pile.

### BRIEF DESCRIPTION OF THE DRAWINGS

FIG. 1 is a schematic diagram showing a sprayed-FRP wet lay-up process.

FIG. 2 is a schematic diagram of the manufacturing process of a sprayed-FRP laminate square plate.

FIG. 3 is schematic stress-strain behavior of sprayed-FRP coupon specimens.

FIG. 4 is the stress-strain behavior of sprayed-FRP confined concrete.

FIG. 5A is a schematic of the test set up in side view.

FIG. 5B is a top view of FIG. 5A.

FIG. 6 is a schematic diagram demonstrating sprayed-FRP applying an external confining pressure on circular reinforced concrete bridge columns

FIG. 7 is a typical single column reinforced concrete circular bridge column configuration.

FIG. 8 is a cross section of reinforced concrete circular bridge column

FIG. 9 represents a schematic of postposed experimental setup of sprayed-FRP retrofitted circular columns.

FIG. 10 represents stress-strain behavior of 3 mm thick sprayed-FRP specimen with 35 mm, and 25%, length and volume fibers, respectively.

FIG. 11 represents stress-strain behavior of 6 mm thick sprayed-FRP specimen with 35 mm, and 25%, length and volume fibers, respectively.

FIG. 12 represents stress-strain behavior of 9 mm thick sprayed-FRP specimen with 35 mm, and 25%, length and volume fibers, respectively.

FIG. 13 represents axia stress-strain behavior unconfined and confined concrete cylinder with sprayed-FRP

FIG. 14 represents an elevation and cross-section of as-built columns

FIG. 15 represents load protocol adopted in the study.

FIG. 16 represents load-displacement (hysteretic) behavior of as-built column.

FIG. 17 represents load-displacement (hysteretic) behavior of as-built columns, and retrofitted column with 3.5 mm sprayed-FRP.

### BRIEF DESCRIPTION OF THE TABLES

Table 1 represents levels of the factors considered for tensile strengths test of sprayed-FRP coupons.

Table 2 represents experimental results of tensile test of sprayed-FRP coupons with various length, volume fraction of fibers and length.

### DETAILED DESCRIPTION OF EMBODIMENTS OF THE INVENTION

In the first embodiment, the sprayed-FRP technique may contain the following:
a) The material and mix proportion of sprayed-FRP
b) Spraying process, one, two, three and multiple layers with different thickness
c) Roll out process
d) Curing of sprayed-FRP
e) Prepare the dog-bone shape specimen from the prepared square sprayed-FRP plate
f) Instrumentation of the sprayed-FRP specimens
g) Uniaxial tensile strength test of sprayed-FRP coupon specimens
h) Plot the stress-stain curve and find the Young's modulus of elasticity of sprayed-FRP

The material is chose from the group such as glass and/or carbon fiber, polyester, epoxy and vinyl ester resin. After the selection of the material, a preferred mix proportion of sprayed-FRP is chosen. Once the mix proportion is ready, the sprayed-FRP of 400 mm×400 mm square plate is prepared with one, two and three layers. Rolling is applied as a rolling process to the square plate to get rid of the air from the sprayed-FRP. Then, the sprayed-FRP laminated square plate is cured at room temperature. The laminated cured specimen is cut in the desired shape and dimension to prepare the tensile strength test of dog-bone shape coupons. The strain gauge is installed on the sprayed-FRP coupons and a uniaxial tensile strength test is conducted to study the stress-strain behavior of the sprayed-FRP coupons.

Before describing the disclosed embodiment further, it is to be understood that the discovery is not limited to its use to the specific procedure revealed since the discovery is capable of further embodiments. Also, the terminology used herein is for the purpose of description and not of restriction.

The following are the preferred, but not necessarily the only, embodiments for the sprayed-FRP strengthening technique.

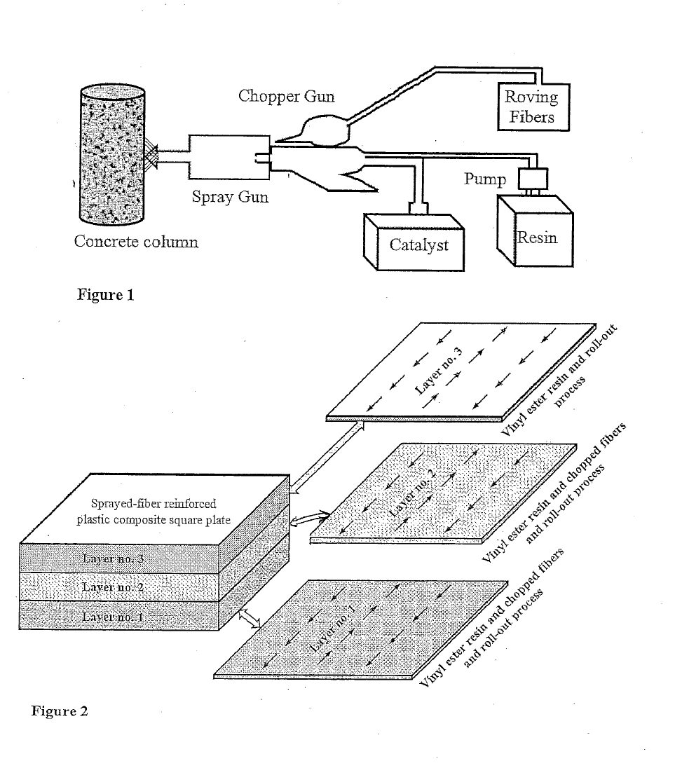

The present disclosure includes a study of sprayed-FRP coupons tensile strength test. The sprayed-FRP coupons are prepared with different thickness (3 mm to 9 mm) with different fiber length (15 to 45 mm) and various volume fractions of fibers (25 to 40%) in a vinyl ester resin. Table 1 and Table 2 show the full factorial design of sprayed-FRP coupon specimen. FIG. 1 shows the sprayed-FRP coupon specimen manufacturing process.

Types of fiber may be glass, carbon, basalt and/or aramid. Types of resin may be polyester, vinyl ester, epoxy, and the like as would be known to one skilled in the art. The fiber and resin combinations may be manufactured by processes such as but not limited to hand lay-up, filament winding, pultrusion and the like as would be known to one skilled in the art. FIG. 1 shows a schematic demonstration of a sprayed-FRP wet lay-up spray process. Hand lay-up spray process is a method of producing sprayed-fiber reinforced plastic components. The fibers can be pre-impregnated with resin (i.e., they are wetted by resin). Rolling can be done to consolidate the fibers in the resin and get rid of any air voids to get the proper bond. FIG. 2 is intended to illustrate that the tensile strength coupon specimens are cut from the cured sprayed-FRP laminated square plate to the desired shape/dimension and machined to the proper acceptances.

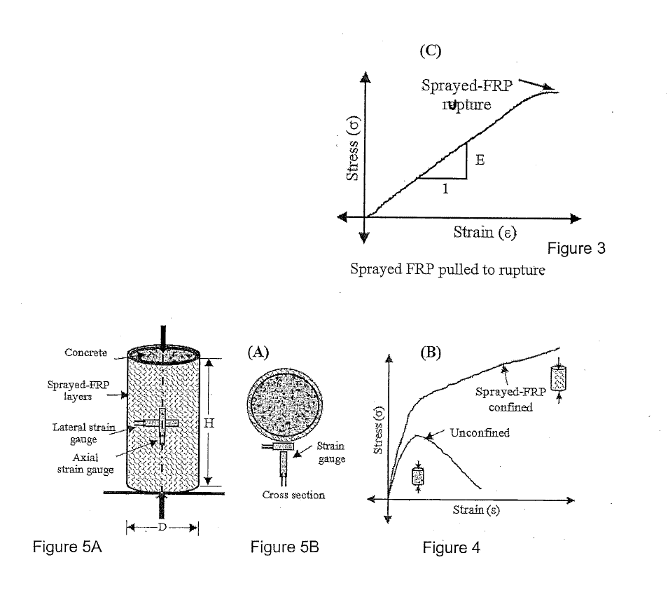

A tensile strength test of sprayed-FRP coupons was performed using an Instron 500 kN capacity universal testing machine. FIG. 3 shows how stress-strain data is plotted to obtain the ultimate tensile strength, the Young's modulus of elasticity and elongation to break.

In a sprayed-FRP durability test, the sprayed-FRP laminated cured coupons and the sprayed-FRP confined concrete cylinder is exposed to a freeze-thaw environment for about 300 to 400 freeze-thaw cycles. The sprayed-FRP laminated cured coupons and the sprayed-FRP confined concrete cylinder are kept in an oven at different temperatures (25 to 80 degrees celsius) for about a 24 hour period. For these durability tests, tensile stress-strain behavior of sprayed-FRP coupons and the sprayed-FRP confined concrete cylinder compressive strength and stress-strain behavior are observed.

In a constitutive model test of sprayed-FRP confined concrete, using not al concrete having a compressive strength of about 35 MPa of 100 mm×200 mm, a concrete cylinder is manufactured, and then encased with the sprayed-FRP composite. The sprayed-FRP confined concrete cylinder was tested under uniaxial compression load with different percentage of mechanical load with respect to the axial capacity of unconfined concrete. FIGS. 5A and 5B show the test set-up of the uniaxial compression test of the sprayed-FRP confined cylinder. The stress-strain behavior was observed for the sprayed-FRP confined concrete with different percentage of axial load and plotted (FIG. 4).

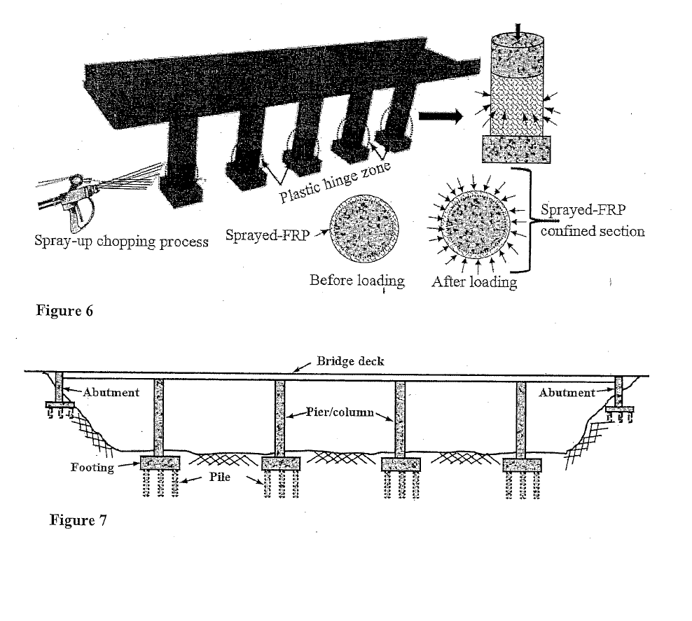

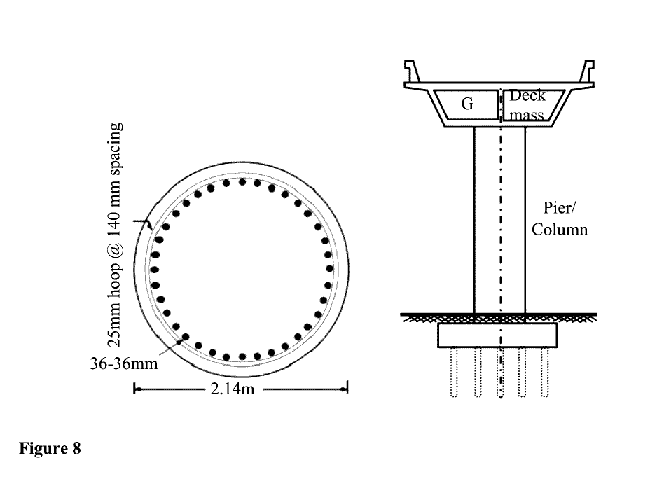

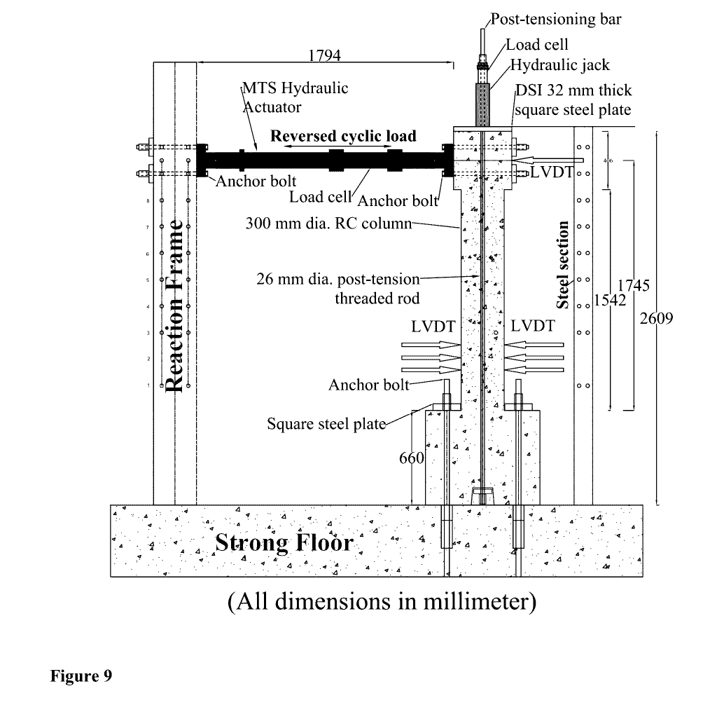

Further testing included a sprayed-FRP strengthened circular reinforced concrete bridge column under constant axial load along with lateral reversed cyclic load to simulate earthquake induced loading and damage. Experimental and numerical investigations were conducted to study the performance of non-seismically designed reinforced concrete (RC) bridge columns retrofitted with sprayed-FRP. FIG. 6 shows schematic illustration of sprayed-FRP applying external confining pressure on a circular RC bridge column FIG. 7 is a typical single column reinforced concrete circular bridge column configuration. FIG. 8 is a cross section of a reinforced concrete circular bridge column. FIG. 9 is a test set up for reversed cyclic load test of circular RC bridge column. The damaged column specimen is retrofitted using sprayed-FRP then tested under reversed cyclic lateral load up to failure to assess remaining lateral load carrying capacity, energy absorption capacity and ductility.

In applicant's view, the sprayed-FRP strengthening technique using glass fiber and vinyl ester resin is preferable, although not intended to be limiting, from a variety of fibers and resin.

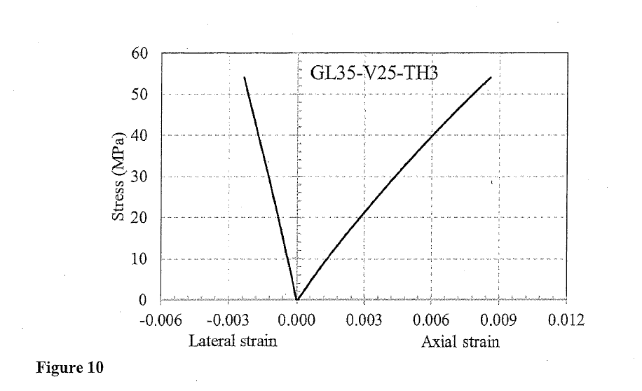

The mechanical properties of a sprayed-FRP coating were tested using a series of tensile strength tests on sprayed-FRP coupons using a factorial design. As described above, the factorial design showing three treatment levels (low, medium and high) are depicted in Table 1. The factorial design matrix and tensile strength test results are presented in Table 2. In the abbreviations in Table 2, for example GL35-V25-TH3, the first letter GL35 represent the glass fiber length is 35 mm, the second letter denotes the volume is fiber of 25%, and the third letters indicate the thickness of coupons is 3 mm The stress-stain behavior for the optimum material composition of the specimens that yielded the best strength are found in FIGS. 10-13 with 3, 6 and 9 mm thick coupons, respectively.

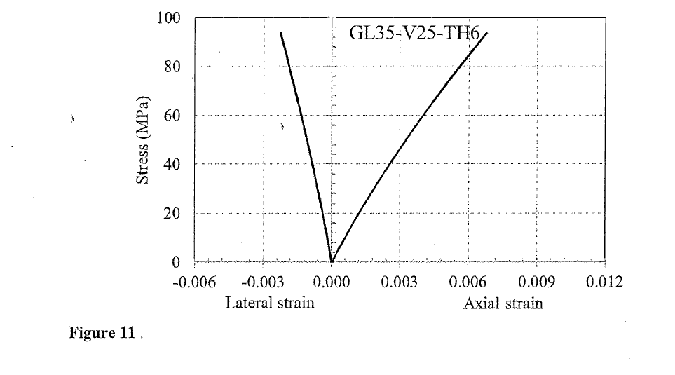

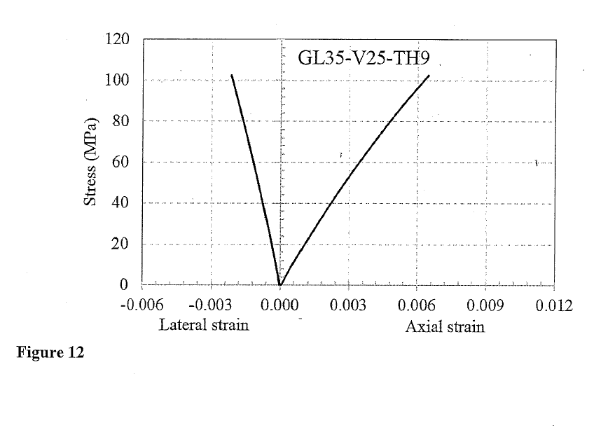

From FIG. 10, it can be observed that the 3 mm thick specimen's average tensile strength and strain were 56 MPa and 0.84%, respectively. From FIG. 11, it can be observed that the 6 mm thick specimen's average tensile strength and strain were 92.3 MPa and 0.72%, respectively. From FIG. 12, it can be observed that the 9 mm thick specimen's average tensile strength and strain was 101.6 MPa and 0.68%, respectively. All the specimens, tensile strength and Young's modulus of elasticy are depicted in Table 2 along with their standard deviation (SD) and coeficient of varation (COV). The results of the material properties tests assist in identifying the otimum materials properties for the sprayed-FRP system for seismic strengthening. The test results indicate that the tensile strength increases with the length of chopped fibers under the condition that the quantity of the fibers in the mixture was greater compared to resin. Based on the performance and construction workability of the chopper gun, seen by way of example in FIGS. 1 and 6, a fiber length of 35 mm and with volume of fiber 30% produced the best strength with the least fiber jumbling.

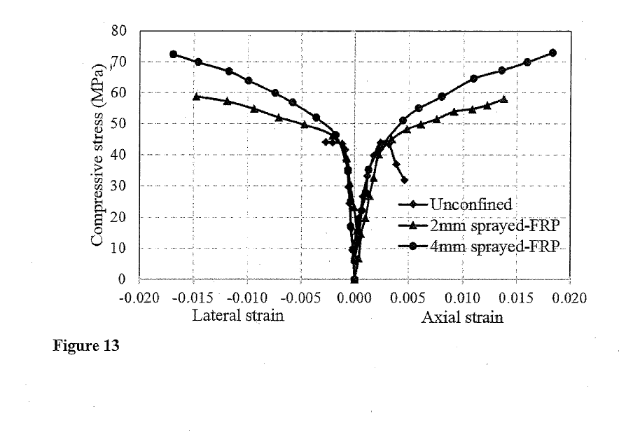

The effectiveness of sprayed-FRP coating was studied by conducting an axial compression test. In the compression test the length and volume of fiber were 35 mm and 30%, respectively. The unconfined compressive strength of the concrete tested was 42 MPa. FIG. 13 shows the axial compression stress-strain relationship of unconfined and confined concrete with 2 and 4 mm thick sprayed-FRP coating. The results show that the sprayed-FRP coating significantly increased the compression strength (41%) and strain (75%) of the confined concrete as compared to the unconfined concrete. It was observed that confined and unconfined specimen stress-strain slope were same, but after a certain limit seen in FIG. 13 cracking occurred on the sprayed-FRP confined specimen which developed the lateral tri-axial state of stress, and the slope of the stress-strain diagram changed. Hence, it may be that the effectiveness of sprayed-FRP confinement is most effective after cracking occurs in the confined specimen. Based on the experimental results, it may be concluded that the sprayed-FRP coating is effective in increasing the compressive strength and strain of concrete.

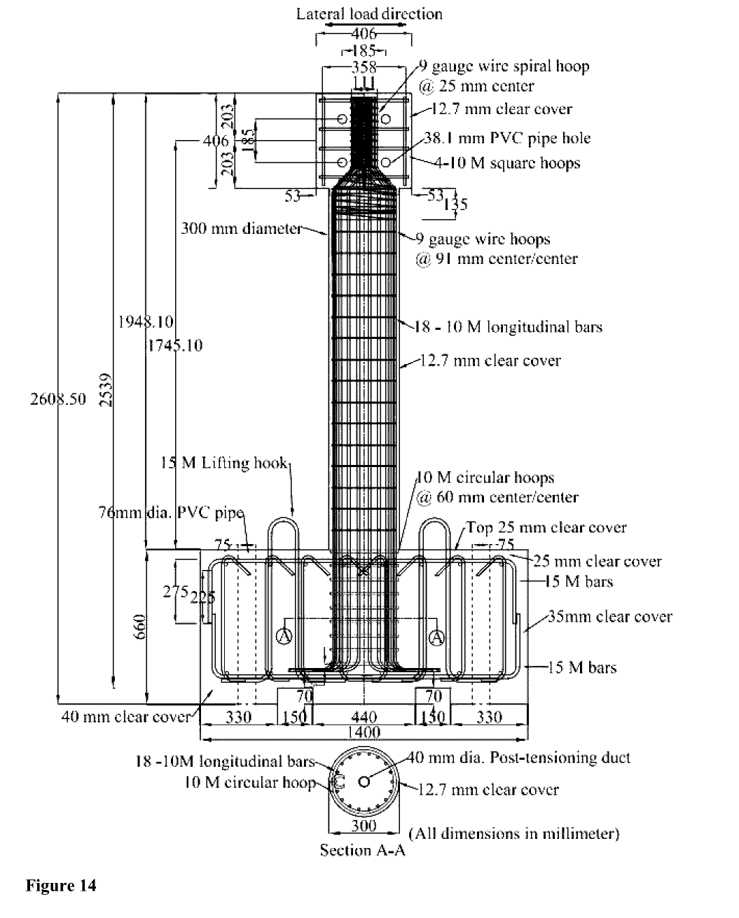

FIG. 14 shows the dimensions of an as-built column and also shows the steel reinforcement detailing. The effective height, and diameter of the columns is 1745 mm, 300 mm, respectively. The column is supported by 1400 mm×800 mm×660 mm footing. In its longitudinal direction the column is reinforced with 18-11.3 mm reinforcing bars, while in the lateral direction, 9 gauge 3.5 mm diameter wire hoops are placed every 91 mm The column was cast using ready mix concrete of 35 MPa. A reduced scale single-cantilever damaged reinforced concrete column was repaired and retrofitted with sprayed-FRP, and tested under cyclic loading.

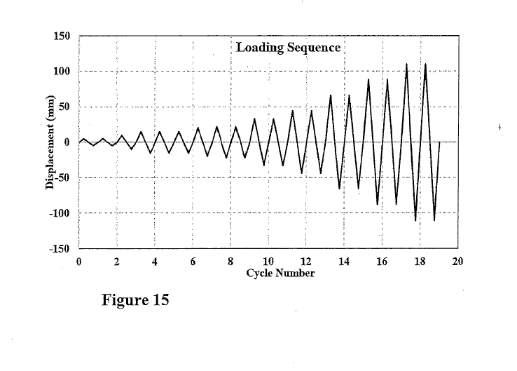

FIG. 9 shows the experimental set-up of the column under lateral revise cyclic load along with constant axial load. The column was damaged under an incrementally increasing displacement-controlled lateral cyclic load. Both columns were subjected to the same load protocol as shown in FIG. 15. To mimic the effect of gravity loads, the axial load on the column was maintained during testing at a value of 116 kN which represents 5% of the column's gross section compressive strength. The reversed cyclic load was applied to the column using hydraulic actuator mounted on the reaction frame.

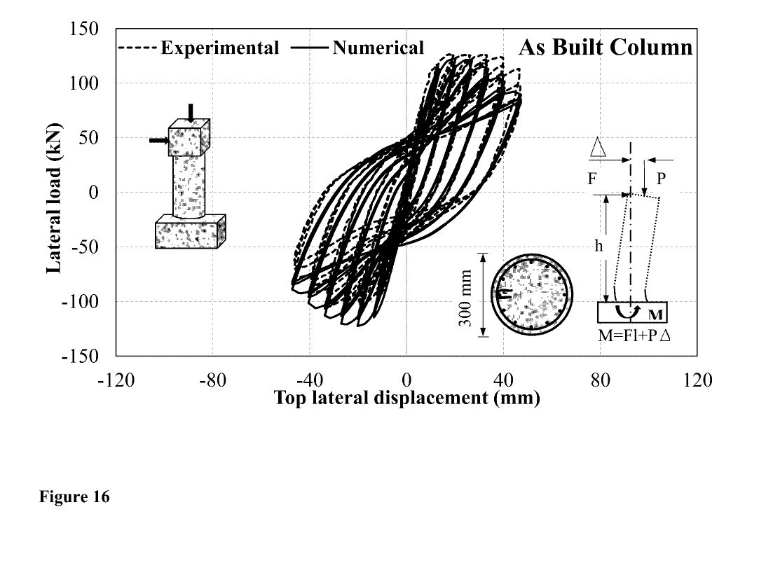

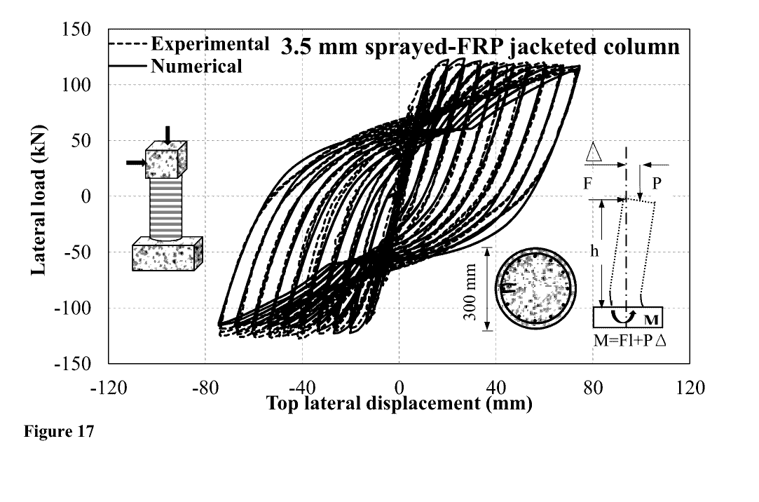

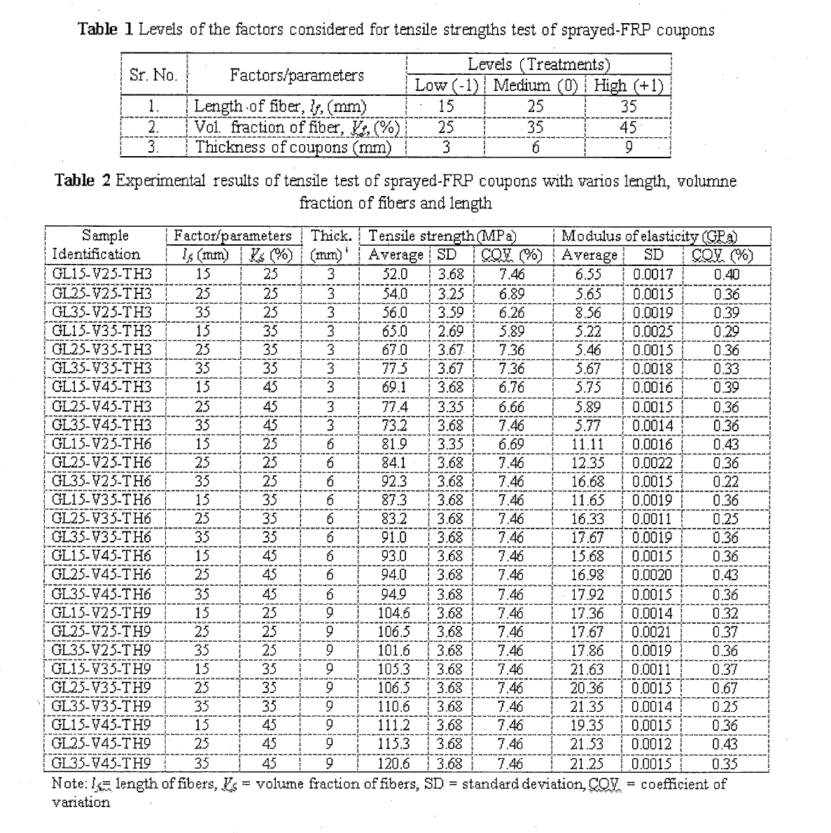

The lateral load versus top lateral displacement response of experimental and numerical results of as-built and sprayed-FRP retrofitted columns under reverse cyclic loading are presented in FIGS. 16 and 17, respectively. It should be noted that both figures are plotted in the same scale. From FIG. 16, it can be observed that the as-built specimen shows stable behavior up to 20 mm displacement, and the strength is degrading. The lateral load carrying capacity of as-built column and sprayed-FRP retrofitted columns specimen differed considerably. The sprayed-FRP retrofitted column started yielding at a drift ratio of 0.73%, and the average maximum strength recorded under pulling and pushing was 110 kN. Comparing the average strength of the retrofitted and as-built columns showed that damaged column was fully restored to the as-built column's lateral strength. The hysteretic behavior of sprayed-FRP-retrofitted column shows superior load carrying capacity compared to the as-built column up to a displacement ductility level of ±6. The sprayed-FRP retrofitted column was able to maintain its load-carrying capacity until the end of the loading protocol without evidence of significant structural deterioration. The sprayed-FRP retrofit provided additional confinement to existing core concrete, and was effective at preventing the columns from bond failure of longitudinal bar buckling, and therefore greatly increased the earthquake resistance of the column.

As will be apparent to those skilled in the art in the light of the foregoing disclosure, many alterations and modifications are possible in the practice of this invention without departing from the spirit or scope thereof.

What is claimed is:

1. A method of strengthening an existing seismically deficient infrastructure constructed from concrete, masonry, steel and/or timber wherein the infrastructure may have a first deficient area, the method comprising repairing any first deficient area of the infrastructure using cement motor and then externally jacking the infrastructure, including the cement motor, in a sprayed fiber reinforced polymer jacket.

2. A sprayed-fiber reinforced polymer composite member, for use in the method of claim 1, for increasing the compressive, tensile, shear and flexural strengths of reinforced concrete bridge column and supports, wherein the member includes:
an external case of sprayed fibre and resin combination where the combination includes substantially 60 to 65% glass fiber and substantially 35 to 40% vinyl ester resin;
wherein the external case encases an internal concrete core so as to provide an axial and circumferential reinforcement for the internal concrete core.

3. The member of claim 2 wherein the member is sprayed fiber reinforced polymer jacketing which includes randomly oriented chopped fibers chosen from the group: glass, carbon, basalt and aramid fibers group; in combination with a resin chosen from the group: vinyl ester, polymer and epoxy resin.

4. The member of claim 3 wherein the external case includes a multilayer of wraps.

5. The member of claim 4 wherein the multi-layer of wraps further includes randomly oriented chopped fiber laminated ply.

6. The member of claim 5 wherein the multi-layer of wraps further includes a layer of randomly distributed fibers sandwiching inner and outer layers of circumferential hoop wraps.

7. A sprayed fiber reinforced polymer composite member for increasing the compressive, shear and flexural strengths of concrete columns and supports comprising an external multilayer case of a fiber and resin combination, wherein the fiber includes at least one or more of: glass, carbon, basalt and aramid, and the resin includes at least one of vinyl ester, polymer and epoxy

8. The sprayed fiber reinforced polymer composite member of claim 7 comprising substantially 60 to 65% of the fibers, and substantially 35 to 35% of the resin by weight or by volume.

9. The sprayed fiber reinforced polymer composite member of claim 8 further comprising an external case formed solely from glass, one of the group comprising carbons.

10. The member of claim 9 wherein the member is adapted to snugly wrap onto a core concrete within the external case, whereby the external case provides axial and circumferential reinforcement for the core concrete.

11. The member of claim 10 wherein the core concrete is a support column or a pile.
